(19) United States
(12) Patent Application Publication
(10) Pub. No.: US 2026/0164399 A1
(43) Pub. Date: Jun. 11, 2026

(54) POSITIONING METHOD AND SYSTEM BASED ON CELL INDEX DATABASE

(71) Applicant: ELECTRONICS AND TELECOMMUNICATIONS RESEARCH INSTITUTE, Daejeon (KR)

(72) Inventors: Youngsu Cho, Daejeon (KR); Jung Ho LEE, Daejeon (KR); Ju Il Jeon, Daejeon (KR)

(21) Appl. No.: 19/409,548

(22) Filed: Dec. 4, 2025

(30) Foreign Application Priority Data
Dec. 9, 2024 (KR) 10-2024-0181710
Dec. 2, 2025 (KR) 10-2025-0187690

(51) Int. Cl. H04W 64/00; H04W 24/10

(52) U.S. Cl. CPC H04W 64/00; H04W 24/10

(57) ABSTRACT

A positioning method and system based on a cell index database are provided. The positioning method is a positioning method of determining a position of a terminal by using the positioning system and includes a step of extracting a search range, which is a space range having a possibility that there is the terminal, from a cell index database based on positioning measurement information collected by the terminal, a step of extracting a space position, corresponding to a serving cell identifier including the positioning measurement information, from a regular positioning database and determining an initial position of the terminal based on the space position, a step of requesting hybrid positioning measurement information collected by the terminal, extracting a space position corresponding to the hybrid positioning measurement information from the regular positioning database, and based thereon, determining a precise position of the terminal.

### CROSS-REFERENCE TO RELATED APPLICATIONS

This application claims priority under 35 U.S.C. §119 to Korean Patent Application Nos. 10-2024-0181710, filed on December 9, 2024, and 10-2025-0187690, December 2, 2025, the disclosure of which is incorporated herein by reference in its entirety.

### BACKGROUND

### Field of the Invention

The present disclosure relates to a method and a system, which may measure a position of an object by using a cell index database so as to shorten a positioning operation time.

### Discussion of the Related Art

Global navigation satellite system (GNSS)-based positioning technology is technology that provides position information about a user terminal, equipped with a GNSS receiver, as a global coordinate system (for example, a latitude, a longitude, an altitude, etc.) by using a GNSS satellite. As the GNSS-based positioning technology is used, a position of an object may be determined in outdoor areas across the globe within an error range of several cm to tens m.

As additional global satellite navigation systems such as Europe's Galileo, Russia's GLONASS, and China's BeiDou have been introduced, position availability and accuracy in outdoor spaces are expected to improve in the future.

However, in indoor and urban dense areas, due to increased multipath errors and weak signal reception caused by building obstruction, positioning is impossible, or positioning accuracy is degraded. Also, the problem where time to first fix (TTFF) increases due to a degradation in visible satellite has occurred.

In positioning technology based on mobile communication base stations, TTFF may be relatively faster than GNSS, but its performance can be affected by base station placement, and position accuracy is generally lower than GNSS.

Generally, base station-based positioning technology is classified as follows.

First, cell-ID technology is a method that maps per-identifier installation position information by using an identifier of a currently accessed base station to calculate a position of a terminal. Position accuracy represents a level of hundreds m to several km, based on coverage. Second, trilateration technology is a method that converts received signal strength between base stations and a terminal into distance information, and then, calculates a position of the terminal by using the distance information and accurate installation position information about the base stations. Time of arrival (ToA) technology is a method that measures an arrival time up to a terminal from base stations to convert into distance information, and then, calculates a position of the terminal by using the distance information and accurate installation position information about the base stations. Time difference of arrival (TDoA) technology is a method that calculates a position of a terminal by using a base station arrival time difference value between two or more pairs. Angle of arrival (AoA) technology is a method that calculates a position of a terminal by using reception angle information and accurate installation position information about base stations when a terminal signal is received from two or more base stations. There is an advantage where there is no special requirement for terminals, but there is a disadvantage where base stations need separate equipment for angle measurement.

Moreover, Wi-Fi-based positioning technology is technology that may provide precise position information with an accuracy of several meters in the inside of buildings or urban dense areas where GNSS signals are not received or a GNSS position error is large, based on signal strength, round-trip time, and angle of arrival from nearby Wi-Fi access points (Wi-Fi Aps). Companies such as Skyhook Wireless, Google, and Apple in the United States are expanding their positioning service availability to metropolitan or nationwide areas through wardriving technology, AP mapping technology, or crowd-sourcing technology.

However, vehicle-based wardriving or AP mapping technology is based on a method where experts collect data, and due to this, has a problem where the cost needed for the initial construction of a Wi-Fi AP database is large. Also, because data collection is performed in outdoor areas, GNSS position information is used for collection positions, and due to this, a problem has occurred where it is impossible to obtain collection positions in indoor areas where GNSS reception is difficult. Also, even in a case where a Wi-Fi AP database is pre-constructed, when a positioning terminal is outside a construction coverage, or a Wi-Fi AP measurement value is intermittently measured or not measured, there is a problem where it is unable to provide position information, and when Wi-Fi APs are moved, installed, or removed, it is needed to update a Wi-Fi AP database through periodic collection. To compensate for such disadvantages to efficiently update a Wi-Fi AP database with the low cost, user participation-based collection methods using mobile applications such as navigation are expanding, but prior consent for the collection, use, and provision of personal position information is needed, and issues such as the non- identification of personal position data and the accuracy of collected positions should be still solved.

Generally, Wi-Fi-based positioning technology is classified as follows. First, there is a method where, when an installation position of a Wi-Fi AP is known, a position of a terminal is calculated by using cell-ID, centroid, and trilateration techniques. Second, there is a fingerprinting or pattern matching method that, when an installation position of a Wi-Fi AP is not known, pre-patterns MAC addresses, received signal strength indication (RSSI), round trip time (RTT), and angle of arrival (AoA) for each Wi-Fi AP received at a reference position capable of knowing an accurate position or calculation, and then, provides, as a terminal position, a reference position having a pattern which is the most similar to a pattern received when positioning in a positioning terminal.

Moreover, in positioning for providing position information for emergency rescue, GNSS, base stations, Wi-Fi, and hybrid positioning technologies are being used. In detail, when an emergency rescue request is received, an emergency rescue agency requests position information for a mobile communication phone number from a position information service provider, and the position information service provider (for example, a mobile network provider) provides the position information calculated by the positioning technology requested by the emergency rescue agency, in conjunction with a rescue-requesting terminal and a positioning server.

On the other hand, because position information may be calculated through only a mobile communication provider to which a rescue request terminal is subscribed at only the time of an emergency rescue request, it is difficult to provide position information corrected by using measurement information accumulated before the emergency rescue request or by using map information. Particularly, in base station-based positioning technology, there are limitations in improving position accuracy because only measurement information from a small number of currently communicating or nearby searched base stations may be used. Also, in order to apply appropriate fingerprinting positioning technology for improving the position accuracy of base stations, Wi-Fi, or hybrid positioning technology, a method of overcoming the following technical problems of positioning databases (DBs) is needed.

1) A problem where position accuracy is reduced when requesting positioning within an uncollected area

2) A problem where, whenever issues such as addition and changing of collected data occur, the issues should be reflected in a positioning database (DB)

3) A problem where an error between a positioning DB and positioning measurement information occurs largely due to a difference between indoor and outdoor measurement environments

### SUMMARY

An aspect of the present disclosure is directed to providing a positioning method and system which may use a cell index database so as to shorten a positioning operation time.

Another aspect of the present disclosure is directed to providing a hierarchical precise positioning method which may compare a cell index database with cell measurement information about a rescue requester terminal to define a search range of a presence-possible position, and thus, may simultaneously satisfy the shortening of an operation time and the improvement of positioning accuracy and availability.

The object of the present disclosure is not limited to the aforesaid, but other objects not described herein will be clearly understood by those skilled in the art from descriptions below.

A positioning method according to an embodiment of the present disclosure is a positioning method of determining a position of a terminal by using a positioning system.

The positioning method includes: a step of receiving positioning measurement information collected by and received from the terminal, requesting at least one of a cell key list and a cell identifier list, each included in the positioning measurement information, from a cell index database, and extracting a search range, which is a space range having a possibility that there is the terminal, from the cell index database; a step of requesting a serving cell identifier, included in the positioning measurement information, from a regular positioning database periodically storing positioning data with being defined to within the search range, extracting a space position corresponding to the serving cell identifier, and determining an initial position of the terminal, based on the space position; a step of requesting at least one of sensor data and short-range communication information, included in the positioning measurement information, from the regular positioning database with being defined to within a certain radius at the initial position and determining a precise position of the terminal, based on a space position extracted in response to the request; and a step of transmitting the precise position to the terminal.

In an embodiment of the present disclosure, the cell key list may include a physical cell identifier (PCI) of a mobile communication base station, channel information, and a serving status information about the base station.

In an embodiment of the present disclosure, the search range may be a space range of a grid matching at least one of the cell key list and the cell identifier list in the cell index database.

In an embodiment of the present disclosure, the step of determining the initial position of the terminal may include: a step of requesting an identifier of an own serving cell, which is accessible by the terminal among the serving cell identifiers, from the regular positioning database, extracting a space position corresponding to the identifier of the own serving cell, and determining the initial position based on a space position corresponding to the identifier of the own serving cell; and a step of, when the space position corresponding to the identifier of the own serving cell is not in the regular positioning database, requesting an identifier of a third-party serving cell, which is inaccessible by the terminal among the serving cell identifiers, from the regular positioning database, extracting a space position corresponding to the identifier of the third-party serving cell, and determining the initial position based on the space position corresponding to the identifier of the third-party serving cell.

In an embodiment of the present disclosure, the positioning method may further include a step of, when the determination of the initial position fails, or the determination of the precise position fails, requesting at least one of the short-range communication information and the sensor data from a temporary positioning database updated in real time based on online positioning data and determining a final position of the terminal, based on a space position extracted in response to the request.

A positioning method according to an embodiment of the present disclosure is a positioning system determining a position of a terminal.

The positioning system includes: a processor; and a memory configured to store one or more instructions executed by the processor.

The one or more instructions include: an instruction of receiving positioning measurement information collected by and received from the terminal, requesting at least one of a cell key list and a cell identifier list, each included in the positioning measurement information, from a cell index database, and extracting a search range, which is a space range having a possibility that there is the terminal, from the cell index database; an instruction of requesting a serving cell identifier, included in the positioning measurement information, from a regular positioning database periodically storing positioning data with being defined to within the search range, extracting a space position corresponding to the serving cell identifier, and determining an initial position of the terminal, based on the space position; an instruction of requesting at least one of sensor data and short-range communication information, included in the positioning measurement information, from the regular positioning database with being defined to within a certain radius at the initial position and determining a precise position of the terminal, based on a space position extracted in response to the request; and an instruction of transmitting the precise position to the terminal.

The present disclosure may define a presence range of a rescue requester terminal through a cell index database, and thus, may simultaneously satisfy the shortening of an operation time and the improvement of positioning accuracy and availability.

Moreover, the present disclosure may additionally use a temporary positioning database, and thus, may be expected to considerably improve positioning availability in a situation where an update period of a regular positioning database is long, or there is a positioning request for emergency rescue of a positioning information uncollected area.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a block diagram illustrating a physical configuration of a positioning system according to an embodiment of the present disclosure.

FIG. 2 is a diagram for describing a functional configuration of the positioning system of FIG. 1 and a positioning method performed by the positioning system.

FIGS. 3A and 3B are diagrams for describing a positioning method according to an embodiment of the present disclosure.

FIG. 4 is a diagram for describing a method of generating a regular positioning database and a temporary positioning database.

### DETAILED DESCRIPTION OF THE INVENTION

The present disclosure may be applied to positioning for emergency rescue. In the present disclosure, "position information for emergency rescue" may denote position information which is provided by a position information provider (for example, a mobile communication provider) based on a request of an emergency rescue agency when an emergency rescue request (for example, Korea 112 or 119, USA 911, and Europe 112 in emergency services) is received.

In positioning for providing position information for emergency rescue, GNSS, base stations, Wi-Fi, and hybrid positioning technologies may be used. In detail, when an emergency rescue request is received, an emergency rescue agency may request, from an position information provider, position information about a mobile communication phone number that has requested rescue, and the position information provider (for example, a mobile communication provider) may provide the emergency rescue agency with the position information calculated based on positioning technology requested by the emergency rescue agency, in conjunction with a rescue request terminal and a positioning server.

On the other hand, because position information may be calculated through only a mobile communication provider to which a rescue request terminal is subscribed at only the time of an emergency rescue request, it is difficult to provide position information corrected by using measurement information accumulated before the emergency rescue request or by using map information. Particularly, in base station-based positioning technology, there are limitations in improving position accuracy because only measurement information from a small number of currently communicating or nearby searched base stations may be used. Also, in order to apply appropriate fingerprinting positioning technology for improving the position accuracy of base stations, Wi-Fi, or hybrid positioning technology, a method of overcoming the following technical problems of a positioning database (hereinafter referred to as a 'positioning DB') is needed.

1) A problem where position accuracy is reduced when requesting positioning within an uncollected area should be solved. In a solution thereof, a machine learning regression analysis method may be used to generate a positioning DB by estimating virtual measurement information of a formalized grid including uncollected points, based on collected data (measurement information for each collection position and positioning infrastructure). On the other hand, because it is unable to predict a point capable of the occurrence of an emergency rescue positioning request beforehand, as collected data expands to a nationwide scale and the amount of data increases, pre-generating a standardized grid-based positioning DB for each positioning infrastructure (for example, base stations, Wi-Fi, BLE, etc.) including uncollected points may need a very long operation time and storage space.

2) Whenever issues such as addition and changing of collected data occur, a method of efficiently reflecting the issues in a positioning DB may be needed. If all positioning DBs for each positioning infrastructure in all areas capable of positioning should be re-generated whenever a small number of collected data are updated, a very inefficient positioning DB generation method may be determined.

3) As an example, when measurement environments of a positioning measurement value (an indoor environment) and a positioning DB estimated from collected data (an outdoor environment) differ, a significant measurement information error (for example, received signal strength) between the positioning DB and the positioning measurement information caused by a difference between indoor and outdoor environments may largely occur. Accordingly, a positioning DB generation method which is independent of the error or is capable of compensation may be needed.

4) A positioning DB generation method that facilitates coupling of positioning resources may be needed for supporting optimal positioning through a combination of heterogeneous positioning infrastructures.

5) Considering the characteristics of position information for emergency rescue, which should simultaneously satisfy both nationwide positioning availability and rapid position information provision, an optimal positioning DB structure and search method for meeting a maximum positioning response time condition when constructing a nationwide positioning DB may be needed.

The present disclosure provides a hierarchical precise positioning method and a system to which the method is applied, which may compare a cell index database with cell measurement information about a rescue requester terminal to define a search range of a presence-possible position, and thus, may simultaneously satisfy the shortening of an operation time and the improvement of positioning accuracy and availability.

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terms used herein are for the purpose of describing particular embodiments only and are not intended to be limited to example embodiments. As used herein, the singular forms "a," "an" and "the" are intended to include the plural forms as well, unless the context clearly indicates otherwise. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof. Hereinafter, embodiments of the present invention will be described in detail with reference to the accompanying drawings.

While terms such as "first" and "second," etc., may be used to describe various components, such components must not be understood as being limited to the above terms. It will be understood that when an element is referred to as being “connected to” another element, it can be directly connected to the other element or intervening elements may also be present.

In contrast, when an element is referred to as being “directly connected to” another element, no intervening elements are present. In addition, unless explicitly described to the contrary, the word “comprise” and variations such as “comprises” or “comprising,” will be understood to imply the inclusion of stated elements but not the exclusion of any other elements. Also, other expressions describing relationships between components such as “~ between”, “immediately ~ between” or “adjacent to ~” and “directly adjacent to ~” may be construed similarly.

In describing embodiments, description on technology which is well known in the technical field of the present invention and is directly irrelevant to the present invention is omitted. This is for more clearly transferring subject matters of the present invention by omitting an unnecessary description in order not to obscure subject matters of the present invention.

Hereinafter, embodiments of the invention will be described in detail with reference to the accompanying drawings. In describing the invention, to facilitate the entire understanding of the invention, like numbers refer to like elements throughout the description of the figures, and a repetitive description on the same element is not provided.

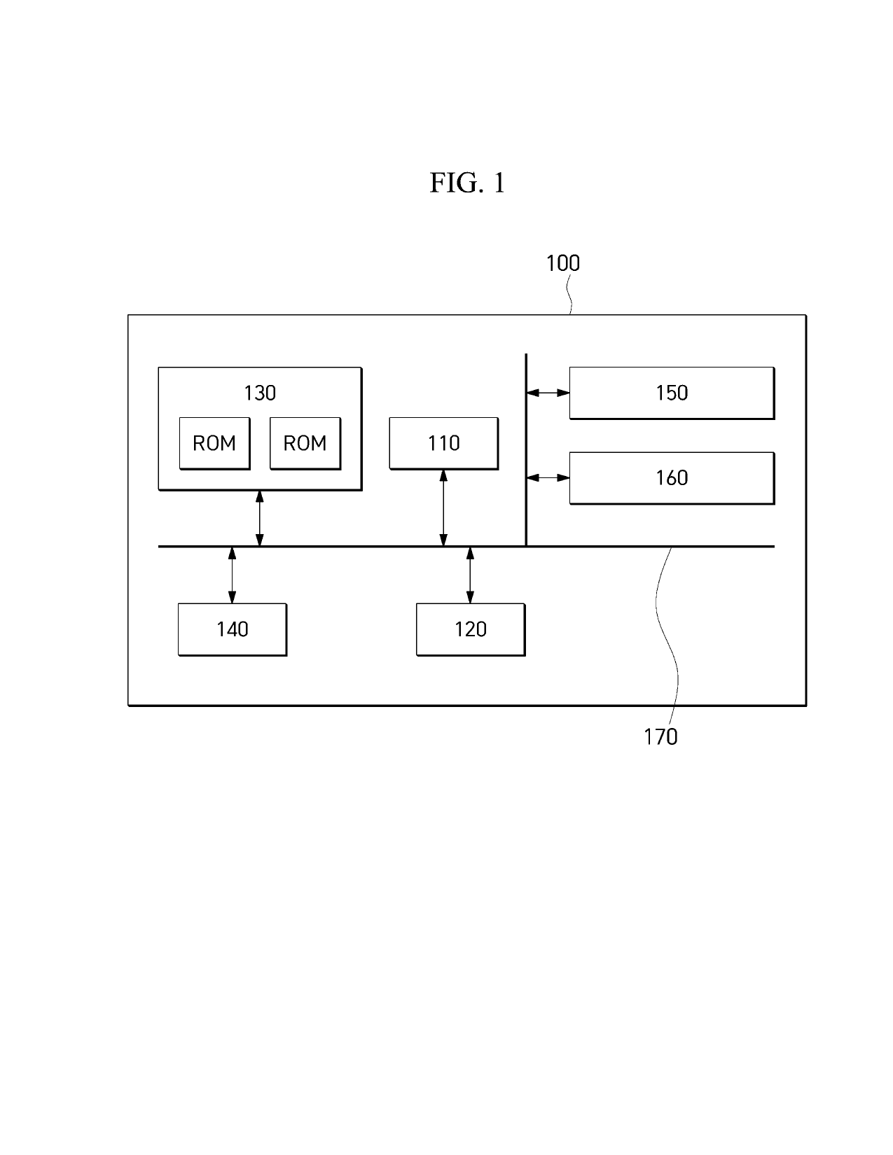

FIG. 1 is a block diagram illustrating a physical configuration of a positioning system 100 according to an embodiment of the present disclosure.

As illustrated in FIG. 1, the positioning system 100 according to an embodiment of the present disclosure may be implemented as a type of computer system.

For reference, unlike FIG. 1, the positioning system 100 according to an embodiment of the present disclosure may be implemented as software or a hardware type such as field programmable gate array (FPGA) or application specific integrated circuit (ASIC).

Referring to FIG. 1, the positioning system 100 according to an embodiment of the present disclosure may include at least one of a processor 110, a communication device 120, a memory 130, a storage device 140, an input interface device 150, an output interface device 160, and a bus 170. The positioning system 100 illustrated in FIG. 1 may be based on an embodiment, and the elements of the positioning system 100 according to an embodiment of the present disclosure are not limited to the embodiment of FIG. 1, and depending on the case, may be added, changed, or deleted.

The processor 110 may be central processing unit (CPU), or may be a semiconductor device which executes computer-readable instructions stored in the memory 130 or the storage device 140. The memory 130 and the storage device 140 may each include volatile or non-volatile storage mediums of various types. For example, the memory 130 may include read-only memory (ROM) and random access memory (RAM). In an embodiment of the present disclosure, the memory 130 may be disposed in or outside the processor 110 and may be connected to the processor 110 through various means well known. The memory 130 may include volatile or non-volatile storage mediums of various types, and for example, may include ROM and RAM.

Therefore, an embodiment of the present disclosure may be implemented as a method implemented in a computer, or may be implemented as a non-transitory computer-readable medium storing an instruction executable by a computer. In an embodiment of the present disclosure, when executed by the processor 110, computer-readable instructions may perform the method according to at least one aspect of the present disclosure.

The communication device 120 may transmit or receive a wired signal or a wireless signal. The communication device 120 may include a wired communication module and a wireless communication module. The wired communication module may be implemented with a power line communication device, a telephone wire communication device, a cable home (MoCA), Ethernet, IEEE1294, an integration wired home network, an RS-485 control device, and/or the like. Also, the wireless communication module may be configured as a module for implementing a function of each of wireless local area network (WLAN), Bluetooth, HDR WPAN, UWB, ZigBee, Impulse Radio, 60GHz WPAN, Binary-CDMA, wireless USB technology, wireless HDMI technology, and/or the like.

Moreover, the input interface device 150 may include at least one of a microphone, a keyboard, a scanner, a touchscreen, a mouse, and a USB port, or a combination thereof. Also, the output interface device 160 may include at least one of a display device, a printer, a three-dimensional (3D) printer, and a speaker, or a combination thereof. However, in the present disclosure, devices such as the input interface device 150 and the output interface device 160 are not limited to the devices described above.

Moreover, an operating method of the positioning system 100 according to embodiments of the present disclosure may be implemented in the form of program instructions capable of being executed through various computer means and may be recorded in a computer-readable recording medium.

The computer-readable recording medium may individually include a program instruction, a data file, and a data structure, or may include a combination thereof. The program instruction recorded in the computer-readable medium may be specially designed and configured for embodiments of the present disclosure, or may be known to those skilled in the art in the field of computer software and may be available. The computer-readable recording medium may include a hardware device configured to store and execute a program instruction. For example, the computer-readable recording medium may include a magnetic storage medium such as a hard disk, a floppy disk, and a magnetic tape, an optical recording medium such as CD-ROM and digital versatile disk (DVD), ROM, RAM, and flash memory. The program instruction may include a machine language code, such as being created by a compiler, and a high-level language code capable of being executed by a computer through an interpreter.

The processor 110 may execute one or more computer-readable instructions stored in the memory 130 or the storage device 140, and thus, may execute a positioning method according to an embodiment of the present disclosure.

The one or more instructions may include an instruction of receiving positioning measurement information D1 collected by and received from a terminal 50, requesting at least one of a cell key list and a cell identifier list, each included in the positioning measurement information D1, from a cell index DB 260, and extracting a search range D2, which is a space range where there is the terminal 50, from the cell index DB 260, an instruction of requesting a serving cell identifier, included in the positioning measurement information D1, from a regular positioning DB(regular positioning database) 270 periodically storing positioning data with being defined to within the search range D2, extracting a space position corresponding to the serving cell identifier, and determining initial positions D3 and D4 of the terminal 50, based on the space position, an instruction of requesting at least one of sensor data and short-range communication information, included in the positioning measurement information D1, from the regular positioning DB 270 with being defined to within a certain radius at the initial positions D3 and D4 and determining a precise position D5 of the terminal 50, based on a space position extracted in response to the request, and an instruction of transmitting the precise position D5 to the terminal 50.

The cell key list included in the positioning measurement information D1 may include a physical cell identifier (PCI) of a mobile communication base station, channel information, and serving-related information about the base station. Also, the search range D2 may be a space range of a grid matching at least one of the cell key list and the cell identifier list, in the cell index DB 260.

The instruction of determining the initial positions D3 and D4 of the terminal 50 may include an instruction of requesting an identifier of an own serving cell, which is accessible by the terminal 50 among serving cell identifiers, from the regular positioning DB 270, extracting a space position corresponding to the identifier of the own serving cell, and determining the initial positions D3 and D4 of the terminal 50, based on the space position corresponding to the identifier of the own serving cell and an instruction of, when the space position corresponding to the identifier of the own serving cell is not in the regular positioning DB 270, requesting an identifier of a third-party serving cell, which is inaccessible by the terminal 50 among the serving cell identifiers, from the regular positioning DB 270, extracting a space position corresponding to the identifier of the third-party serving cell, and determining the initial positions D3 and D4 of the terminal 50, based on the space position corresponding to the identifier of the third-party serving cell.

Moreover, the one or more instructions may further include an instruction of, when the determination of the initial positions D3 and D4 of the terminal 50 fails, or the determination of the precise position D5 of the terminal 50 fails, requesting at least one of the short-range communication information and the sensor data as hybrid positioning measurement information D1', included in the positioning measurement information D1 collected by the terminal 50, from a temporary positioning DB 280 updated in real time based on online positioning data and determining a final position of the terminal 50, based on a space position extracted in response to the request.

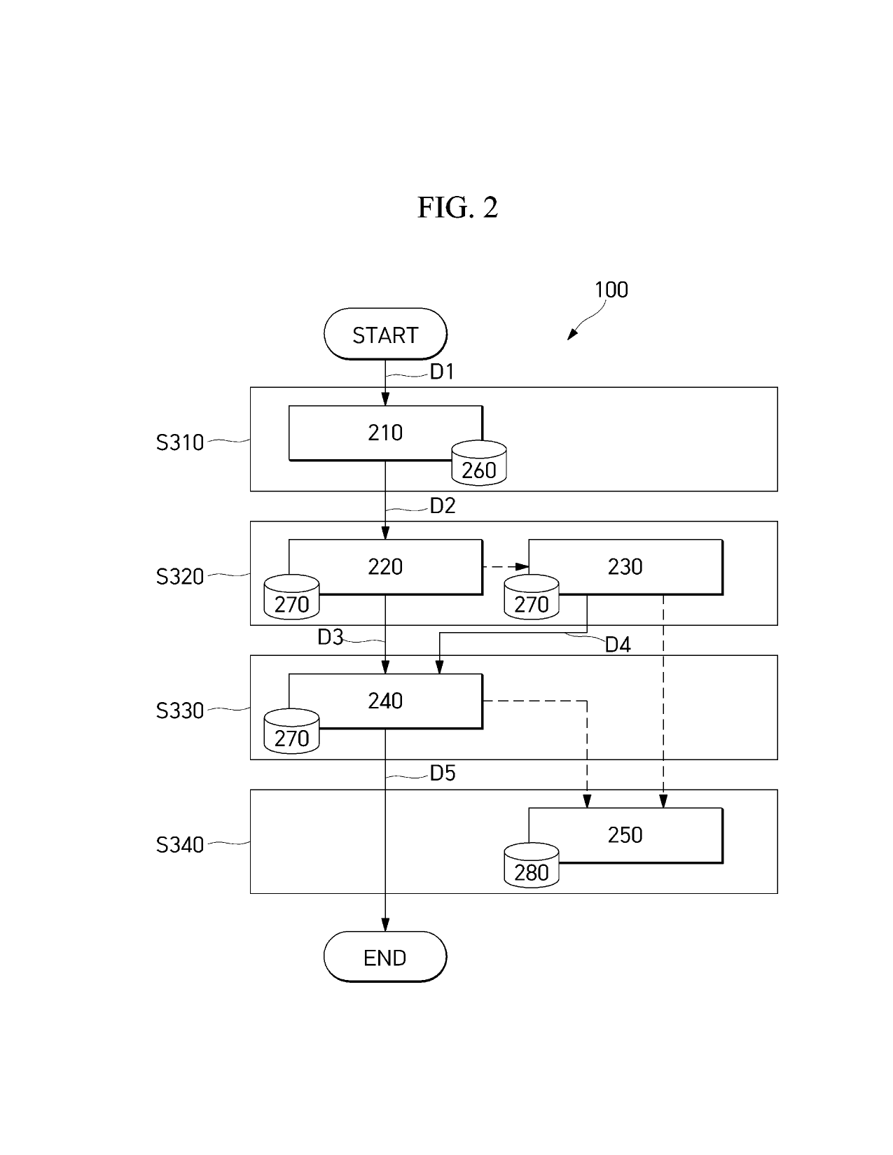

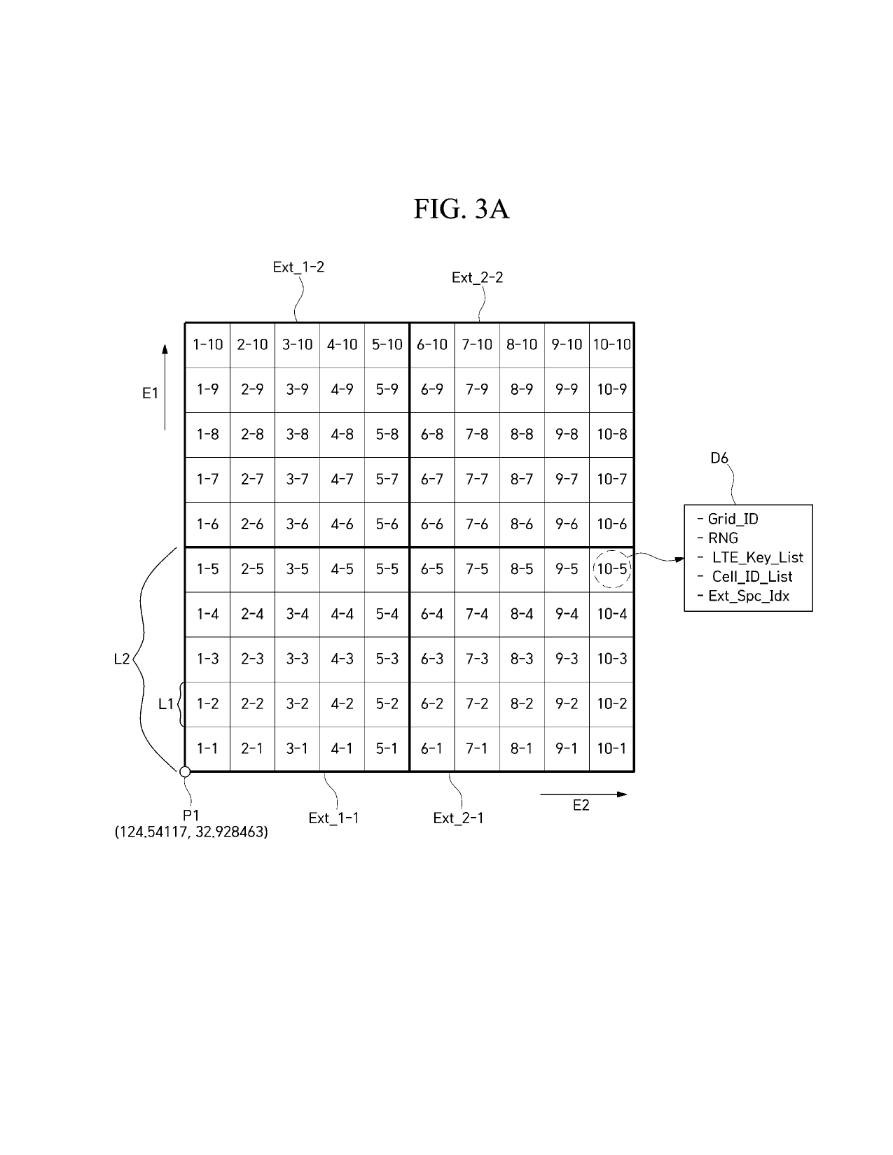

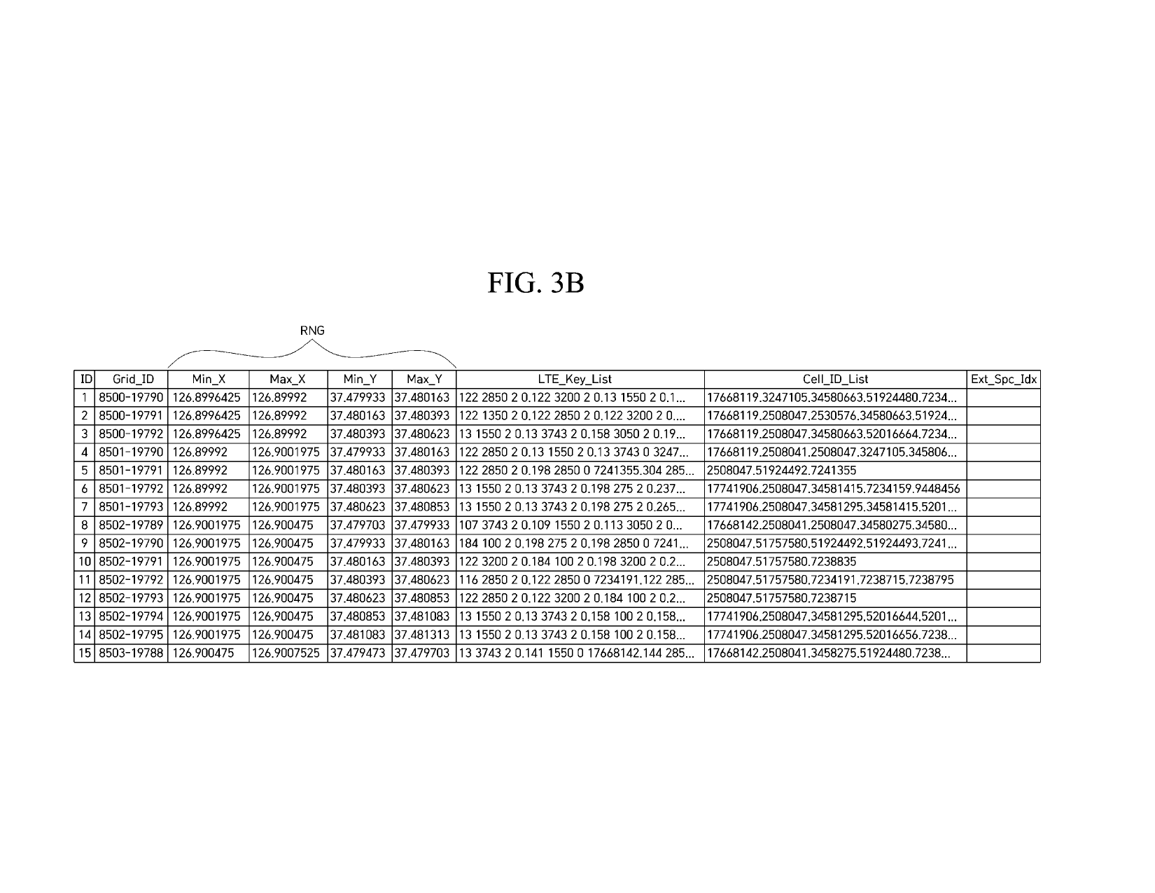

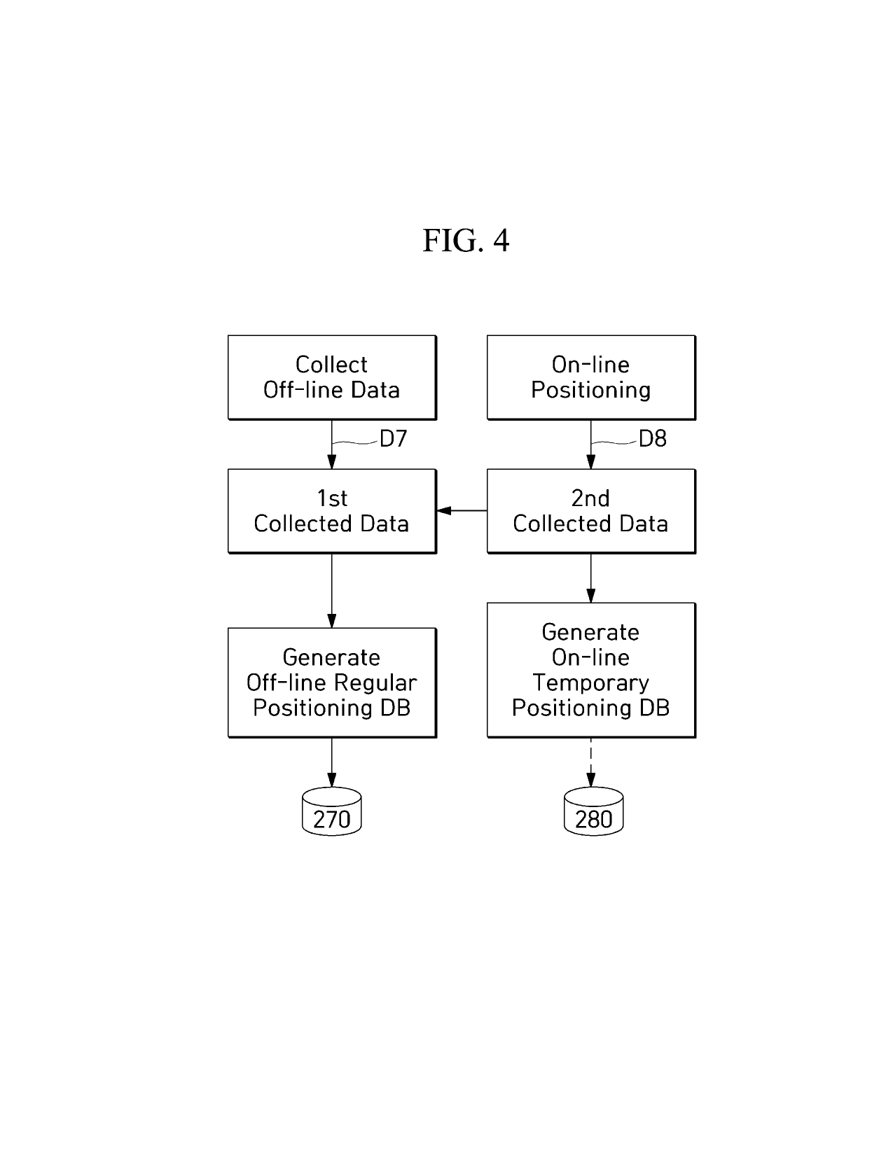

FIG. 2 is a diagram for describing a functional configuration of the positioning system of FIG. 1 and a positioning method performed by the positioning system, FIGS. 3A and 3B are diagrams for describing a positioning method according to an embodiment of the present disclosure, and FIG. 4 is a diagram for describing a method of generating a regular positioning DB and a temporary positioning DB. In detail, the positioning method may be a hierarchical precise positioning method based on a cell index.

As illustrated in FIG. 2, the positioning system 100 may include a cell index unit 210, an initial cell positioning unit 220, a precise cell positioning unit 230, a hybrid positioning unit 240, a correction unit 250, a cell index DB 260, a regular positioning DB 270, and a temporary positioning DB 280. The positioning system 100 illustrated in FIG. 2 may be based on an embodiment, and the functional elements of the positioning system 100 according to an embodiment of the present disclosure are not limited to the embodiment of FIG. 2, and depending on the case, a new element may be added, or the elements illustrated in FIG. 2 may be changed, integrated, or deleted.

For convenience of description, a positioning target object of the positioning system 100 according to an embodiment of the present disclosure may be assumed to be the terminal 50 of a rescue requester.

As illustrated in FIG. 2, the positioning system 100 may perform precise positioning via steps S310 to S340. The positioning system 100 illustrated in FIG. 2 may be based on an embodiment, and steps of the positioning method according to an embodiment of the present disclosure are not limited to the embodiment of FIG. 2, and depending on the case, another step may be added, or the step illustrated in FIG. 2 may be changed or deleted.

Step S310 may be a step of determining a search range of a terminal by using positioning measurement information.

In step S310, the cell index unit 210 may receive the positioning measurement information D1 collected by the terminal 50 which is a positioning target object and may transfer a request written based on the positioning measurement information D1 to the cell index DB 260 to obtain the search range D2 where there may be the terminal 50. That is, the cell index unit 210 may request the positioning measurement information D1 from the cell index DB 260 to obtain the search range D2 where there may be the terminal 50 which is the positioning target object. The search range D2 may be area (space range) information where there may be the terminal 50.

In the present disclosure, the positioning measurement information D1 may be positioning information directly measured by the terminal 50, or may be positioning information indirectly estimated by coupling the positioning information estimated by the terminal 50 to other information, and may denote arbitrary information capable of being used in position calculation. For example, the positioning measurement information D1 may include information such as an identifier (for example, a physical cell identifier (PCI), cell-ID, etc.), channel information, and a serving status (an identifier of a base station or a cell currently being served) of a mobile communication base station (for example, 3G/LTE/5G/6G, etc.) constructed nationwide. In the present disclosure, a cell identifier may be represented as cell-ID or a cell identifier (CID). In this case, an identifier of a base station (or a cell) may include an identifier of a base station (or a cell) of a mobile communication provider (hereinafter referred to as an 'own company') to which the terminal 50 is subscribed and an identifier of a base station (or a cell) of a mobile communication provider (hereinafter referred to as a 'third company') to which the terminal 50 is not subscribed. That is, the positioning measurement information D1 may include all of identifiers of base stations (or cells) of an own company and a third company (hereinafter referred to as an 'own serving cell identifier' or a 'third-party serving cell identifier'), which are being served currently.

The cell index DB 260 may include correlation information between the positioning measurement information D1 and a space range where there may be corresponding measurement information.

FIGS. 3A and 3B are diagrams illustrating a cell index DB. In the present embodiment, cell index information D6 may be index information about LTE cell and may be information stored in the cell index DB 260.

The cell index information D6 may include a grid ID (Grid_ID), a space range of a corresponding grid (RNG), a cell key list (LTE_Key_List), a cell identifier list (Cell_ID_List), and an extension space index (Ext_Spc_Idx). For example, the cell key list (LTE_Key_List) may include an identifier (PCI or CID) of a base station, channel information, and a serving status (a serving flag).

In FIG. 3A, each grid included in a positioning target area may be represented by an identification sign (Grid_ID) such as 1-1, 1-2, ..., and 10-10. Also, an extension space may consist of a set of a plurality of gris and may be represented by an identification sign (Ext_Spc_Idx) such as Ext_1-1, Ext_1-2, .... Each grid may have a rectangular shape or a square shape. In the embodiment of FIG. 3A, each grid may have a square shape, and a length of one side may be L1 (for example, 5 m). Also, a side length of the extension space may be represented by L2 (for example, 25 m). P1 may be a position of a reference point of a positioning target area, and a grid may extend in an E1 or E2 direction.

FIG. 3B is an example of the cell index DB 260. In the present embodiment, the cell index information D6 of the cell index DB 260 may include an ID, a grid ID (Grid_ID), a grid space range (RNG), a cell key list (LTE_Key_List), a cell identifier list (Cell_ID_List), and an extension space index (Ext_Spc_Idx). The grid space range (RNG) may be defined as a longitude range (Min_X, Max_X) and a latitude range (Min_Y, Max_Y).

The cell index unit 210 may request a cell key list or a cell identifier list, included in the positioning measurement information D1 collected and transmitted by the terminal 50, from the cell index DB 260, may obtain a grid ID (Grid_ID) corresponding to the cell key list or the cell identifier list from the cell index DB 260, and may selectively search for a space range (RNG), where there may be a corresponding terminal 50, from the cell index DB 260 by using the grid ID (Grid_ID). In this case, the space range (RNG) may correspond to the search range D2 of the terminal 50.

The cell index DB 260 may be modified and generated in various structures, in addition to the embodiment described above, and the regular positioning DB 270 may be generated through modification or parsing.

Referring again to FIG. 2, step S320 will be described below.

Step S320 may be a step of determining an initial position of the terminal 50 withing a search range of the terminal 50.

The initial cell positioning unit 220 or the precise cell positioning unit 230 may determine the initial positions D3 and D4 of the terminal 50 within the search range D2 of the terminal 50, based on the regular positioning DB 270 which is previously constructed.

The initial cell positioning unit 220 may determine the initial position D3 of the terminal 50 within the search range D2 which is obtained in step S310. The initial cell positioning unit 220 may request an own serving cell identifier of the terminal 50 from the regular positioning DB 270 within the search range D2, may search for a space position of a grid ID corresponding to the own serving cell identifier from the regular positioning DB 270, and may calculate the initial position D3 by using the space position of the grid ID. That is, the initial cell positioning unit 220 may determine the initial position D3 of the terminal 50 corresponding to the own serving cell identifier within the search range D2 by using the regular positioning DB 270.

For example, when the initial cell positioning unit 220 fails in the determination of the initial position D3 fails (in FIG. 2, illustrated by a dotted line toward 230 from 220), the precise cell positioning unit 230 may additionally operate to calculate the initial position D4. The precise cell positioning unit 230 may request the own serving cell identifier (measurement) and/or the third-party serving cell identifier (estimation), each provided by a rescue requester terminal, from the regular positioning DB 270 within the search range D2, may search for a space position of a grid ID corresponding thereto, and may calculate the initial position D4 of the terminal 50 by using the space position of the grid ID. For example, even in a case where an identifier of the own serving cell is not in the regular positioning DB 270, when an identifier of a serving cell estimated as a third company is in the regular positioning DB 270, the precise cell positioning unit 230 may calculate the initial position D4 of the terminal 50.

For example, when the precise cell positioning unit 230 fails in the determination of initial position of the terminal 50 (in FIG. 2, illustrated by a dotted line toward 250 from 230), the correction unit 250 may perform final positioning after proceeding to step S340.

When the determination of initial position D3 or D4 of the terminal 50 succeeds in step S320, step S330 may be performed, and otherwise, step S340 may be performed.

Step S330 may be a step of determining a precise position of a terminal within a search range of the terminal.

The hybrid cell positioning unit 240 may receive the hybrid positioning measurement information D1' collected by the terminal 50. The hybrid positioning measurement information D1' may be included in the positioning measurement information D1 which is input in step S310, or may be newly input in step S330.

In the present disclosure, the hybrid positioning measurement information D1' may include information such as an identifier (for example, a physical cell identifier (PCI), cell-ID, etc.), channel information, and a serving status (an identifier of a base station or a cell currently being served) of a mobile communication base station (for example, 3G/LTE/5G/6G, etc.) constructed nationwide, and moreover, may include information collected by the terminal 50 through short-range communication (for example, Wi-Fi, BLE, UWB, NFC, RFID, etc.), information obtained by processing information collected through short-range communication, data collected by a sensor (for example, GNSS, an accelerometer, a gyroscope, a geomagnetic sensor, a barometer, a camera, LiDAR, a temperature sensor, a humidity sensor, a microphone, etc.), and data generated by processing sensor data.

The hybrid cell positioning unit 240 may request the hybrid positioning measurement information D1' from the regular positioning DB 270, may search for a space position of a grid ID corresponding to the hybrid positioning measurement information D1', and may determine the precise position D5 of the terminal 50 based on the found space position, within a search range in a certain radius from the approximate initial positions D3 and D4 of the terminal 50 calculated through the initial cell positioning unit 220 or the precise cell positioning unit 230 or within the search range D2 determined by the cell index unit 210. On the other hand, as the kind and measurement list of hybrid positioning measurement information D1' increase, a comparison operation time with data stored in the precise positioning DB 270 may increase, and thus, a positioning operation time may be shortened when the hybrid cell positioning unit 240 issues a request to the regular positioning DB 270 with being defined to within a search range in a certain radius from the initial positions D3 and D4.

When the obtainment of precise position D5 of the terminal 50 succeeds in step S330, the positioning system 100 may transmit the precise position D5 to the terminal 50 and may end a positioning process, and otherwise, step S340 may be performed (in FIG. 2, illustrated by a dotted line toward 250 from 240).

Step S340 may be a step where the correction unit 250 calculates the final position of the terminal 50 when step S320 or step S330 fails.

The correction unit 250 may request the hybrid positioning measurement information D1' of the terminal 50 from the temporary positioning DB 280 instead of the regular positioning DB 270, may search for a space position of a grid ID corresponding to the hybrid positioning measurement information D1', and may determine the final position of the terminal 50 based on the found space position. That is, the correction unit 250 may compare the hybrid positioning measurement information D1' with positioning data included in the temporary positioning DB 280 and may calculate the final position of the terminal 50 by using a space position of a grid ID having a correlation with the hybrid positioning measurement information D1'.

Like step S330, the correction unit 250 may request the hybrid positioning measurement information D1' from the temporal positioning DB 280, may search for a space position of a grid ID corresponding to the hybrid positioning measurement information D1', and may determine the final position of the terminal 50 based on the found space position, within a search range in a certain radius from the initial positions D3 and D4 of the terminal 50 or within the search range D2 determined by the cell index unit 210.

The positioning system 100 may directly/indirectly transmit the final position of the terminal 50 to the terminal 50.

FIG. 4 is a diagram for describing a method of generating a regular positioning DB and a temporary positioning DB. A construction method and a difference between the regular positioning DB 270 and the temporary positioning DB 280 will be described below with reference to FIG. 4.

In the present disclosure, the temporary positioning DB 280 may denote a positioning database which is temporarily generated by the positioning system 100 in real time by using online positioning measurement information D8 (for example, positioning data generated or processed based on GNSS, a base station, short-range communication, a sensor, etc.) capable of being collected by terminal 50 and/or the positioning system 100. On the other hand, the regular positioning DB 270 may denote a positioning database which is regularly generated by a manager by using all of offline positioning measurement information D7 and the online positioning measurement information D8.

The positioning system 100 may construct the regular positioning DB 270, based on the offline positioning measurement information D7 and the online positioning measurement information D8, and may construct the temporary positioning DB 280, based on the online positioning measurement information D8. Therefore, in FIG. 4, first collected data may include the offline positioning measurement information D7 and the online positioning measurement information D8, and second collected data may include only the online positioning measurement information D8. The temporary positioning DB 280 may be a database which is updated in real time and may be shorter in update period than the regular positioning DB 270.

Considering a characteristic where the offline positioning measurement information D7 is massive, it may not be easy to newly generate or update in real time the regular positioning DB 270. Accordingly, the positioning system 100 according to an embodiment of the present disclosure may generate or update the temporary positioning DB 280 in real time by using the online positioning measurement information D8, and thus, may prevent positioning fail caused by that the regular positioning DB 270 is not generated or is lately updated and may provide a fast positioning DB corresponding to an uncollected area nationwide, thereby improving position availability.

The positioning method described above has been described with reference to the flowchart illustrated in FIG. 2. To provide a simple description, the method is illustrated as a series of blocks and has been described, but the present disclosure is not limited to the order of the blocks, and some blocks and the other blocks may be executed simultaneously or in order which differs from the illustration and description of the present disclosure, and various other branches and flow paths and the orders of blocks for accomplishing the same or similar results may be implemented. Also, all blocks illustrated for implementing the method described in the present disclosure may not be needed.

In the above descriptions of FIGS. 2 to 4, based on an implementation example of the present disclosure, each step may be further divided into additional steps, or may be combined into fewer steps. Also, depending on the case, some steps may be omitted, and the order of steps may be changed. Despite other omitted descriptions, the description of FIG. 1 may be applied to the descriptions of FIGS. 2 to 4. Also, the descriptions of FIGS. 2 to 4 may be applied to the description of FIG. 1.

The present disclosure may define a presence range of a rescue requester terminal through a cell index database, and thus, may simultaneously satisfy the shortening of an operation time and the improvement of positioning accuracy and availability.

Moreover, the present disclosure may additionally use a temporary positioning database, and thus, may be expected to considerably improve positioning availability in a situation where an update period of a regular positioning database is long, or there is a positioning request for emergency rescue of a positioning information uncollected area.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A positioning method of determining a position of a terminal by using a positioning system, the positioning method comprising:
a step of receiving positioning measurement information collected by and received from the terminal, requesting at least one of a cell key list and a cell identifier list, each included in the positioning measurement information, from a cell index database, and extracting a search range, which is a space range having a possibility that there is the terminal, from the cell index database;
a step of requesting a serving cell identifier, included in the positioning measurement information, from a regular positioning database periodically storing positioning data with being defined to within the search range, extracting a space position corresponding to the serving cell identifier, and determining an initial position of the terminal, based on the space position;
a step of requesting at least one of sensor data and short-range communication information, included in the positioning measurement information, from the regular positioning database with being defined to within a certain radius at the initial position and determining a precise position of the terminal, based on a space position extracted in response to the request; and
a step of transmitting the precise position to the terminal.

2. The positioning method of claim 1, wherein the cell key list comprises a physical cell identifier (PCI) of a mobile communication base station, channel information, and a serving status information about the base station.

3. The positioning method of claim 1, wherein the search range is a space range of a grid matching at least one of the cell key list and the cell identifier list in the cell index database.

4. The positioning method of claim 1, wherein the step of determining the initial position of the terminal comprises:
a step of requesting an identifier of an own serving cell, which is accessible by the terminal among the serving cell identifiers, from the regular positioning database, extracting a space position corresponding to the identifier of the own serving cell, and determining the initial position based on a space position corresponding to the identifier of the own serving cell; and
a step of, when the space position corresponding to the identifier of the own serving cell is not in the regular positioning database, requesting an identifier of a third-party serving cell, which is inaccessible by the terminal among the serving cell identifiers, from the regular positioning database, extracting a space position corresponding to the identifier of the third-party serving cell, and determining the initial position based on the space position corresponding to the identifier of the third-party serving cell.

5. The positioning method of claim 1, further comprising a step of, when the determination of the initial position fails, or the determination of the precise position fails, requesting at least one of the short-range communication information and the sensor data from a temporary positioning database updated in real time based on online positioning data and determining a final position of the terminal, based on a space position extracted in response to the request.

6. A positioning system determining a position of a terminal, the positioning system comprising:
a processor; and
a memory configured to store one or more instructions executed by the processor,
wherein the one or more instructions comprise:
an instruction of receiving positioning measurement information collected by and received from the terminal, requesting at least one of a cell key list and a cell identifier list, each included in the positioning measurement information, from a cell index database, and extracting a search range, which is a space range having a possibility that there is the terminal, from the cell index database;
an instruction of requesting a serving cell identifier, included in the positioning measurement information, from a regular positioning database periodically storing positioning data with being defined to within the search range, extracting a space position corresponding to the serving cell identifier, and determining an initial position of the terminal, based on the space position;
an instruction of requesting at least one of sensor data and short-range communication information, included in the positioning measurement information, from the regular positioning database with being defined to within a certain radius at the initial position and determining a precise position of the terminal, based on a space position extracted in response to the request; and
an instruction of transmitting the precise position to the terminal.

7. The positioning system of claim 6, wherein the cell key list comprises a physical cell identifier (PCI) of a mobile communication base station, channel information, and a serving status information about the base station.

8. The positioning system of claim 6, wherein the search range is a space range of a grid matching at least one of the cell key list and the cell identifier list in the cell index database.

9. The positioning system of claim 6, wherein the instruction of determining the initial position of the terminal comprises:
an instruction of requesting an identifier of an own serving cell, which is accessible by the terminal among the serving cell identifiers, from the regular positioning database, extracting a space position corresponding to the identifier of the own serving cell, and determining the initial position based on a space position corresponding to the identifier of the own serving cell; and
an instruction of, when the space position corresponding to the identifier of the own serving cell is not in the regular positioning database, requesting an identifier of a third-party serving cell, which is inaccessible by the terminal among the serving cell identifiers, from the regular positioning database, extracting a space position corresponding to the identifier of the third-party serving cell, and determining the initial position based on the space position corresponding to the identifier of the third-party serving cell.

10. The positioning system of claim 6, wherein the one or more instructions further comprise an instruction of, when the determination of the initial position fails, or the determination of the precise position fails, requesting at least one of the short-range communication information and the sensor data from a temporary positioning database updated in real time based on online positioning data and determining a final position of the terminal, based on a space position extracted in response to the request.
